(19) United States
(12) Patent Application Publication
(10) Pub. No.: US 2015/0259578 A1
(43) Pub. Date: Sep. 17, 2015

(54) HOT MELT ADHESIVE COMPOSITIONS THAT INCLUDE PROPYLENE POLYMER AND ETHYLENE COPOLYMER

(71) Applicant: H.B. FULLER COMPANY, St. Paul, MN (US)

(72) Inventors: Cheryl A. Jones, Minneapolis, MN (US); Kim Larson, White Bear Lake, MN (US); Ameara S. Mansour, Woodbury, MN (US); Kevin P. Burge, North St. Paul, MN (US); Beth M. Eichler-Johnson, St. Paul, MN (US)

(21) Appl. No.: 14/639,769

(22) Filed: Mar. 5, 2015

Related U.S. Application Data
(60) Provisional application No. 61/953,020, filed on Mar. 14, 2014.

(51) Int. Cl. C09J 131/04; C09J 123/14

(52) U.S. Cl. CPC C09J 131/04; C09J 123/14; C09J 2201/61

(57) ABSTRACT

Disclosed is a hot melt adhesive composition that includes a polymer component that includes a propylene polymer that includes greater than 50 mole % propylene and exhibiting a melt index greater than 150 grams per ten minutes at 190° C., and an ethylene copolymer exhibiting a melt index of at least 200 grams per ten minutes at 190° C. and an acid number of no greater than 2 mg KOH/g, and derived from ethylene and a co-monomer selected from the group consisting of vinyl acetate, alkyl acrylate, alkyl methacrylate, and combinations thereof, from 0% by weight to no greater than 8% by weight amorphous polyalphaolefin, and from 0% by weight to no greater than 25% by weight oil.

### CROSS-REFERENCE TO RELATED APPLICATIONS

This application claims the benefit of U.S. Provisional Application No. 61/953,020, filed Mar. 14, 2014, which is incorporated herein.

### BACKGROUND

The invention is directed to formulating hot melt adhesive compositions that include polypropylene and ethylene copolymer.

Hot melt adhesive compositions are solid at room temperature and melt at higher temperatures. Hot melt adhesive compositions are often made from a variety of different base polymers including amorphous polyalphaolefins and ethylene vinyl acetate. Many amorphous polypropylene polymers exhibit a long open time, are quite tacky immediately after solidifying from a molten state, and remain tacky for an undesirable period of time after solidifying. These properties are undesirable for applications that require short open times and non-tacky properties after solidification.

It is often difficult to formulate hot melt adhesive compositions that include both polypropylene and ethylene vinyl acetate as the base polymers and that exhibit suitable adhesive properties. One reason for this difficulty is that ethylene vinyl acetate tends to be incompatible with polypropylene.

It would be useful to formulate a hot melt adhesive composition that exhibits good bonding properties at a low coat weight and in which the base polymer of the formulation can be changed while maintaining good adhesive properties.

### SUMMARY

In one aspect, the invention features a hot melt adhesive composition that includes at least 55% by weight of a polymer component that includes a propylene polymer other than an amorphous polyalphaolefin, the propylene polymer including greater than 50 mole % propylene and exhibiting a melt index greater than 150 grams per ten minutes at 190° C. and an ethylene copolymer that exhibits a melt index of at least 200 grams per ten minutes at 190° C. and an acid number no greater than 2 milligrams of potassium hydroxide per grain (mg KOH/g) of ethylene copolymer, and that is derived from ethylene and a co-monomer selected from the group consisting of vinyl acetate, alkyl acrylate, alkyl methacrylate, and combinations thereof, the ratio of the weight of the propylene polymer to the weight of the ethylene copolymer being from 86:14 to 24:76, from 0% by weight to no greater than 8% by weight amorphous polyalphaolefin, and from 0% by weight to no greater than 25% by weight oil, the hot melt adhesive composition exhibiting at least one property selected from the group consisting of a strain at break of from at least 50% to no greater than about 630%, a tensile strength of at least 1.7 megaPascals (MPa), an energy to break of at least 0.15 Joules, and combinations thereof.

In another aspect, the invention features a hot melt adhesive composition that includes at least 35% by weight of a polymer component that includes a propylene polymer other than an amorphous polyalphaolefin, the propylene polymer including greater than 50 mole % propylene and exhibits a melt index of at least 150 grams per ten minutes at 190° C., and an ethylene copolymer that exhibits a melt index of at least 200 grams per ten minutes at 190° C. and derived from ethylene and a co-monomer selected from the group consisting of vinyl acetate, alkyl acrylate, alkyl methacrylate, and combinations thereof, the ratio of the weight of the propylene polymer to the weight of the ethylene copolymer being from 50:50 to 24:76, from 0% by weight to no greater than 8% by weight amorphous polyalphaolefin, and from 0% by weight to no greater than 25% by weight oil, the adhesive composition exhibiting a viscosity no greater than 5,000 centipoise at 177° C.

In other aspects, the invention features a hot melt adhesive composition that includes at least 35% by weight of a polymer component that includes a propylene polymer other than an amorphous polyalphaolefin, the propylene polymer including greater than 50 mole % propylene and exhibits a melt index greater than 150 grams per ten minutes at 190° C., and ethylene vinyl acetate that exhibits a melt index of at least 200 grams per ten minutes at 190° C., the ratio of the weight of the propylene polymer to the weight of the ethylene vinyl acetate being from 86:14 to 24:76, at least 9% by weight of the propylene polymer, from at least 12% by weight to no greater than 50% by weight of the ethylene vinyl acetate, from 0% by weight to no greater than 8% by weight amorphous polyalphaolefin, and no greater than 25% by weight oil.

In one embodiment, the ethylene copolymer includes ethylene vinyl acetate. In some embodiments, the ethylene copolymer has a vinyl acetate content of no greater than 28% by weight. In another embodiment, the ethylene copolymer has an acid number of no greater than 2 mg KOH/g of ethylene copolymer.

In some embodiments, the ratio of the weight of the propylene polymer to the weight of the ethylene copolymer is from 84:16 to 32:68. In other embodiments, the ratio of the weight of the propylene polymer to the weight of the ethylene copolymer is from 84:16 to 50:50. In another embodiment, the ratio of the weight of the propylene polymer to the weight of the ethylene copolymer is from 80:20 to 50:50.

In other embodiments, the ethylene copolymer exhibits a melt index of at least 350 g/10 min at 190° C.

In some embodiments, the hot melt adhesive composition includes at least 60% by weight of the polymer component. In other embodiments, the hot melt adhesive composition includes at least 65% by weight of the polymer component. In one embodiment, the hot melt adhesive composition includes from about 15% by weight to about 80% by weight propylene polymer and from about 10.5% by weight to about 60% by weight ethylene copolymer.

In one embodiment, the propylene polymer exhibits a polydispersity index of no greater than 10. In another embodiment, the propylene polymer includes a single site catalyzed propylene polymer.

In some embodiments, the propylene polymer is derived from propylene and an alpha-olefin co-monomer that includes two carbon atoms, greater than four carbon atoms, or a combination thereof, the propylene polymer including at least 80 mole % propylene and no greater than 20 mole % alpha-olefin co-monomer.

In other embodiments, the hot melt adhesive composition further includes a tackifying agent, a wax, a plasticizer other than oil, or a combination thereof. In one embodiment, the hot melt adhesive composition further includes from about 5% by weight to about 30% by weight of a tackifying agent. In another embodiment, the hot melt adhesive composition includes from 1% by weight to no greater than about 20% by weight oil.

In some embodiments, the hot melt adhesive composition further includes a wax selected from the group consisting of polyethylene wax, polypropylene wax, Fischer Tropsch wax, paraffin wax, maleated polypropylene wax, maleated polyethylene wax, and combinations thereof.

In one embodiment, the hot melt adhesive composition includes from about 20% by weight to about 80% by weight propylene polymer, from about 12% by weight to about 50% by weight ethylene copolymer, from about 2% by weight to about 45% by weight tackifying agent, from about 2% by weight to about 45% by weight wax, and from about 2% by weight to about 25% by weight plasticizer other than oil, oil or a combination thereof. In one embodiment, the wax includes a first wax and a second wax different from the first wax.

In another embodiment, the hot melt adhesive composition exhibits at least 60% fiber tear at 60° C. In some embodiments, the hot melt adhesive composition exhibits at least 60% fiber tear at 22° C. In other embodiments, the hot melt adhesive composition exhibits at least 60% fiber tear at 4° C. In another embodiment, the hot melt adhesive composition exhibits at least 60% fiber tear at −18° C.

In some embodiments, the hot melt adhesive composition exhibits a peel adhesive failure temperature of at least 49° C. In other embodiments, the hot melt adhesive composition exhibits a peel adhesive failure temperature of at least 54° C. In another embodiment, the hot melt adhesive composition exhibits a strain at break of from 50% to 600%. In other embodiments, the hot melt adhesive composition exhibits a strain at break of from 50% to about 300%.

In one embodiment, the hot melt adhesive composition exhibits a tensile strength of at least 2 MPa. In other embodiments, the hot melt adhesive composition exhibits a tensile strength of from 2.4 MPa to about 8.3 MPa.

In some embodiments, the hot melt adhesive composition exhibits an energy to break of at least 0.3 Joules. In other embodiments, the hot melt adhesive composition exhibits an energy to break of at least 0.6 Joules. In another embodiment, the hot melt adhesive composition exhibits an energy to break of from 0.15 Joules to about 5 Joules. In one embodiment, the hot melt adhesive composition exhibits an energy to break of from 0.15 Joules to about 3 Joules.

In another embodiment, the hot melt adhesive composition exhibits a viscosity of no greater than 6000 centipoise at 177° C. In other embodiments, the hot melt adhesive composition exhibits a viscosity of no greater than 2,000 centipoise at 177° C. In one embodiment, the hot melt adhesive composition exhibits a viscosity of no greater than 1500 centipoise at 177° C.

In other aspects, the invention features a method of applying a hot melt adhesive composition disclosed herein, the method including melting the hot melt adhesive composition in a vessel defining a volume no greater than about 1 liter and applying the hot melt adhesive composition on a substrate.

The invention features hot melt adhesive compositions that exhibit good adhesion at low coat weights. The invention also features hot melt adhesive compositions in which the polymer component of the formulation can be changed while maintaining good adhesive properties.

Other features and advantages will be apparent from the following description of the preferred embodiments and from the claims.

### GLOSSARY

In reference to the invention, these terms have the meanings set forth below:

A “wax” has a weight average molecular weight that is less than 20,000 grams per mole (g/mole).

A “polymer” has a weight average molecular weight that is greater than 20,000 g/mole.

### DETAILED DESCRIPTION

### Hot Melt Adhesive Composition

The hot melt adhesive composition includes a polymer component that includes a propylene polymer and an ethylene copolymer. The hot melt adhesive composition includes at least about 35% by weight, at least about 45% by weight, at least about 55% by weight, at least about 60% by weight, at least about 65% by weight, from about 55% by weight to about 95% by weight, from about 60% by weight to about 95% by weight, or even from about 70% by weight to about 90% by weight of the polymer component. The ratio of the weight of the propylene polymer to the weight of the ethylene copolymer in the hot melt adhesive composition is from about 86:14 to about 24:76, from about 86:14 to about 32:68, from about 84:16 to about 32:68, from about 84:16 to about 50:50, or even from about 50:50 to about 24:76.

The hot melt adhesive composition preferably forms a fiber tearing bond at −18° C. and at 60° C., and preferably exhibits at least about 40%, at least about 50%, at least about 60%, at least about 70%, at least about 90%, or even 100% fiber tear at −18° C., 4° C., 22° C., 60° C., or even 65° C.

The hot melt adhesive composition exhibits a viscosity of no greater than about 12,000 centipoise (cP), no greater than about 10,000 cP, no greater than about 6,000 cP, no greater than about 4,500 cP, no greater than about 3,000 cP, no greater than about 2,500 cP, no greater than about 2,000 cP, or even no greater than about 1,500 cP, at 177° C.

The hot melt adhesive composition also exhibits a set time of no greater than 15 seconds, no greater than 10 seconds, no greater than 8.5 seconds, no greater than 7 seconds, no greater than 5 seconds, or even no greater than 3 seconds.

The hot melt adhesive composition preferably exhibits a strain at break of at least 5%, at least 10%, at least 50%, at least about 75%, at least about 100%, at least about 200%, no greater than about 800%, no greater than about 750%, no greater than about 600%, no greater than about 300%, from about 50% to about 600%, or even from about 50% to about 300%, a tensile strength of at least 1.7 megaPascals (MPa) (250 pounds per square inch (psi)), at least about 2.0 MPa (290 psi), at least about 2.4 MPa (348 psi), or even from about 2.4 MPa to about 8.3 MPa (1200 psi), an energy to break of at least 0.03 Joules (J), at least 0.15 J, at least about 0.20 J, at least about 0.25 J, at least about 0.30 J, at least about 0.40 J, from about 0.15 J to about 5 J, or even from about 0.15 J to about 3 J, or a combination thereof.

The hot melt adhesive composition also preferably exhibits a peel adhesive failure temperature of at least 43° C., at least about 49° C., at least about 54° C., or even at least about 60° C., a heat stress resistance of at least 46° C., at least 57° C., at least 60° C., or even at least 63° C., or a combination thereof.

Propylene Polymer

The propylene polymer is a polypropylene homopolymer, a propylene copolymer (i.e., copolymer, terpolymer, and higher order polymer), or a mixture thereof. The propylene polymer can be uni- or multi-modal and can be a mixture of at least two different propylene polymers. The term “multi modal” means the polymer has a multi-modal molecular weight distribution (Mw/MN) as detennined by Size Exclusion Chromatography (SEC). A multi-modal molecular weight distribution exists when the the SEC trace has more than one peak or inflection point (i.e., two or more inflection points). An inflection point is the point at which the second derivative changes in sign (e.g., from negative to positive or vice versa). The term “uni-model” means the polymer has a uni-modal molecular weight distribution (Mw/Mn) as determined by SEC. A uni-modal molecular weight distribution exists when the SEC trace has only one peak or inflection point. Methods for determining molecular weight (i.e., Mw, Mn, and Mz) and modality using SEC are described in U.S. Pat. No. 7,294,681 B2, col. 91, line 11 through col. 92, line 64, which is incorporated herein.

Useful propylene copolymers are derived from propylene and an alpha-olefin co-monomer (e.g., alpha-olefin monomers having at least two carbon atoms, at least four carbon atoms, and combinations of such monomers). Useful alpha-olefin co-monomers include, e.g., mono-alpha olefins (i.e., one unsaturated double bond) and higher order alpha olefins (e.g., dienes (e.g., 1,9-decadiene) and trienes). Useful alpha-olefin monomers include, e.g., ethylene, butene, pentene, hexene, heptene, octene, nonene, decene, dodecene, 4-methyl-pentene-1, 3-methyl pentene-1,3,5,5-trimethyl-hexene-1, 5-ethyl-1-nonene, and combinations thereof. Specific examples of suitable propylene-alpha-olefin copolymers include propylene-ethylene, propylene-butene, propylene-hexene, propylene-octene, and combinations thereof.

The propylene polymer includes at least 50 mole %, at least about 60 mole %, at least about 70 mole %, at least about 80 mole %, at least about 90 mole %, at least about 95 mole %, or even from 50 mole % to about 100 mole % propylene.

The propylene polymer optionally includes at least 2 mole %, at least about 4 mole %, at least about 7 mole %, at least about 10 mole %, no greater than 50 mole %, no greater than 30 mole %, or even no greater than 20 mole % alpha-olefin co-monomer.

Useful propylene polymers exhibit a melt index (MI) of at least 150 grams per 10 minutes (g/10 min), at least about 300 g/10 min, or even at least about 500 g/10 min at 190° C. when tested according to ASTM D 1238-04C using a 2.16 kg weight. Useful propylene polymers exhibit a viscosity of no greater than 12,000 centipoise (cP), no greater than 10,000 cP, no greater than 8,000 cP, no greater than 5,000 cP, no greater than 3,000 cP, no greater than 2,000 cP, or even no greater than 1,000 cP, at 190° C.

Useful propylene polymers have a polydispersity index (Mw/Mn) of no greater than 10, no greater than about 8, no greater than about 5, no greater than about 4, or even no greater than about 3.

Useful propylene polymers include propylene polymers prepared using, e.g., a single site catalyst (e.g., metallocene catalysts (e.g., metallocene-catalyzed propylene polymers)), non-metallocene heteroaryl catalysts, and combinations thereof.

Suitable propylene polymers are commercially available under a variety of trade designations including, e.g., LINXAR propylene-hexene copolymers from ExxonMobil Chemical Company (Houston, Tex.), the L-MODU series of trade designations from Idemitsu Kosan Co., Ltd (Japan) including, e.g., L-MODU S400, S600, and S901 propylene homopolymers, the VISTAMAXX propylene-ethylene copolymers from ExxonMobil Chemical Company (Houston, Tex.) including, e.g., VISTAMAXX 6202 and 2330, and the LICOCENE propylene-ethylene copolymers from Clariant Int'l Ltd. (Muttenz, Switzerland) including, e.g., LICOCENE PP 1502 TP, PP 1602 TP and PP 2602 TP.

The hot melt adhesive composition includes at least about 9% by weight, from about 9% by weight to about 90% by weight, from about 15% by weight to about 80% by weight, from about 20% by weight to about 80% by weight, or even from about 30% by weight to about 70% by weight propylene polymer.

Ethylene Copolymer

The ethylene copolymer is derived from ethylene and a co-monomer that includes vinyl unsaturation examples of which include vinyl acetate, alkyl acrylate, alkyl methacrylate, and combinations thereof. Useful ethylene copolymers include, e.g., ethylene vinyl acetate, ethylene acrylate, ethylene methacrylate, ethylene methyl methacrylate, ethylene n-butylacrylate, ethylene 2-ethyl hexyl acrylate, and combinations thereof.

Useful ethylene copolymers have a melt index of at least 200 g/10 min, at least about 350 g/10 min, at least about 400 g/10 min, at least about 450 g/10 min, at least about 500 g/10 min, at least about 800 g/10 min, at least about 1,000 g/10 min, or even at least about 2,500 g/10 min at 190° C. when tested according to ASTM D 1238-04C using a 2.16 kg weight.

The ethylene copolymer preferably has an acid number of no greater than 3 milligrams (mg) potassium hydroxide (KOH) per gram (g) of ethylene copolymer, no greater than 2 mg KOH/g, or even no greater than 1 mg KOH/g, as determined according to ASTM D-1994-07.

Useful ethylene vinyl acetate copolymers have a vinyl acetate content of no greater than 50% by weight, no greater than 33% by weight, no greater than 28% by weight, from about 12% by weight to about 40% by weight, or even from about 14% by weight to about 28% by weight.

Useful ethylene copolymers are available under a variety of trade designations including, e.g., ESCORENE MV 02514 ethylene vinyl acetate from ExxonMobil Chemical Company (Houston, Tex.), ATEVA 1880A ethylene vinyl acetate from Celanese (Irving, Tex.), ENABLE EN33330 ethylene n-butylacrylate from ExxonMobil Chemical Company (Houston, Tex.), LOTRYL 35 ethylene n-butylacrylate from Arkema (Colombes, France), and K2090 ethylene methyl methacrylate from Celanese (Irving, Tex.).

The hot melt adhesive composition includes at least about 9% by weight, at least about 10% by weight, at least about 10.5% by weight, at least about 12% by weight, at least about 15% by weight, from about 10.5% by weight to about 60% by weight, from about 12% by weight to about 50% by weight, from about 20% by weight to about 45% by weight, or even from about 33% by weight to about 45% by weight ethylene copolymer.

Tackifying Agent

The hot melt adhesive composition optionally includes a tackifying agent. Tackifying agents suitable for use in the adhesive composition preferably have Ring and Ball softening point of less than about 160° C., less than about 150° C., or even less than about 140° C. Suitable classes of tackifying agents include, e.g., aromatic, aliphatic and cycloaliphatic hydrocarbon resins, mixed aromatic and aliphatic modified hydrocarbon resins, aromatic modified aliphatic hydrocarbon resins, and hydrogenated versions thereof; terpenes, modified terpenes and hydrogenated versions thereof; natural rosins, modified rosins, rosin esters, and hydrogenated versions thereof; low molecular weight polylactic acid; and combinations thereof. Examples of useful natural and modified rosins include gum rosin, wood rosin, tall oil rosin, distilled rosin, hydrogenated rosin, dimerized rosin, and polymerized rosin. Examples of useful rosin esters include e.g., glycerol esters of pale wood rosin, glycerol esters of hydrogenated rosin, glycerol esters of polymerized rosin, pentaerythritol esters of natural and modified rosins including pentaerythritol esters of pale wood rosin, pentaerythritol esters of hydrogenated rosin, pentaerythritol esters of tall oil rosin, phenolic-modified pentaerythritol esters of rosin, and combinations thereof. Examples of useful polyterpene resins include polyterpene resins having a softening point, as determined by ASTM method E28-58T, of from about 10° C. to about 160° C., hydrogenated polyterpene resins, and copolymers and terpolymers of natural terpenes (e.g. styrene-terpene, alpha-methyl styrene-terpene and vinyl toluene-terpene), and combinations thereof. Examples of useful aliphatic and cycloaliphatic petroleum hydrocarbon resins include aliphatic and cycloaliphatic petroleum hydrocarbon resins having Ring and Ball softening points of from about 10° C. to 160° C., the hydrogenated derivatives thereof, and combinations thereof. Suitable aliphatic and cycloaliphatic petroleum hydrocarbon resins include, e.g., branched, unbranched, and cyclic C5 resins, C9 resins, and C10 resins.

Useful tackifying agents are commercially available under a variety of trade designations including, e.g., the ESCOREZ series of trade designations from ExxonMobil Chemical Company (Houston, Tex.) including, e.g., ESCOREZ 5400, ESCOREZ 5415, ESCOREZ 5600, ESCOREZ 5615, ESCOREZ 5637, and ESCOREZ 5690, the EASTOTAC series of trade designations from Eastman Chemical Company (Kingsport, Tenn.) including, e.g., EASTOTAC H-100R, EASTOTAC H-100L, EASTOTAC H130W, and EASTOTAC H142, the WINGTACK series of trade designations from Cray Valley HSC (Exton, Pa.) including, e.g., WINGTACK 86, WINGTACK EXTRA, and WINGTACK 95, the PICCOTAC series of trade designations from Eastman Chemical Company (Kingsport, Tenn.) including, e.g., PICCOTAC 8095, the ARKON series of trade designations from Arkawa Europe GmbH (Germany) including, e.g., ARKON P-125, and the REGALITE series of trade designations from Eastman Chemical Company including, e.g., REGALITE R1125.

The hot melt adhesive composition optionally includes from about 0% by weight to about 45% by weight, at least about 2% by weight, from about 2% by weight to about 45% by weight, from about 5% by weight to about 30% by weight, or even from about 10% by weight to about 25% by weight tackifying agent.

Wax

The hot melt adhesive composition optionally includes wax. Classes of useful waxes include, e.g., functionalized waxes (waxes that include a polar functional group), non-functionalized waxes (i.e., waxes that do not include a polar functional group), and mixtures thereof. Useful functionalized waxes include, e.g., functionalized polyethylene wax (e.g., maleated polyethylene wax and oxidized polyethylene wax), functionalized polypropylene wax (e.g., maleated polypropylene wax and oxidized polypropylene wax), polar waxes, functionalized stearamide waxes (e.g., hydroxystearamide, N-(2-hydroxy ethyl)-12-hydroxystearamide, N,N′-ethylene bis 12-hydroxystearamide, and 12-hydroxy stearic acid N,N′ethylene-bis stearamide), and combinations thereof. Useful non-functionalized waxes include, e.g., Fischer Tropsch waxes, polyolefin waxes (e.g., polypropylene waxes and polyethylene waxes), stearamide waxes, benzoate ester waxes, animal waxes, vegetable waxes, paraffin waxes, microcrystalline waxes, metallocene waxes, glycerin monostearate, sorbitan monostearate, and combinations thereof.

Useful commercially available functionalized waxes include, e.g., A-C 597P and A-C 596P maleated polypropylene wax, and A-C 573 maleated polyethylene wax from Honeywell Int'l Inc. (Morristown, N.J.).

Useful polypropylene waxes are commercially available under a variety of trade designations including, e.g., HONEYWELL AC1089 from Honeywell Int'l Inc. and LICOCENE 6102 from Clariant Int'l Ltd. (Muttenz, Switzerland).

Useful polyethylene waxes are commercially available under a variety of trade designations including, e.g., the POLYWAX series of trade designations including POLYWAX 3000 from Baker Hughes (Houston, Tex.), CWP 400 from SSI CHUSEI, Inc. (Pasedena, Tex.), the EPOLENE series of trade designations from Westlake Chemical Corporation (Houston, Tex.) including, e.g., EPOLENE N-21 and N-14 polyethylene waxes, the BARECO series of trade designations from Baker Hughes Inc. (Sugar Land, Tex.) including, e.g., BARECO C4040 polyethylene wax, and the AC series of trade designations from Honeywell Int'l Inc. (Morristown, N.J.) including, e.g., A-C 8 and A-C 9 polyethylene waxes.

Useful Fischer Tropsch waxes are commercially available under a variety of trade designations including, e.g., the BARECO series of trade designations from Baker Hughes Inc. (Sugar Land, Tex.) including, e.g., BARECO PX-100 and PX-105 Fischer Tropsch waxes, the SHELLWAX series of trade designations from Shell Malaysia Ltd. (Kuala Lumpur, Malaysia) including, e.g., SHELLWAX SX100 and SX105 Fischer Tropsch waxes, the VESTOWAX series of trade designations from Evonik Industries AG (Germany) including, e.g., VESTOWAX 2050 Fischer Tropsch wax, and the SASOLWAX series of trade designations from Sasol Wax North America Corporation (Hayward, Calif.) including, e.g., SASOLWAX H105, C80, HI, and H4 Fischer Tropsch waxes.

Useful paraffin waxes are available under a variety of trade designations including, e.g., PARVAN 1580 and 1520 paraffin waxes from ExxonMobil Chemical Company (Houston, Tex.).

When present, the hot melt adhesive composition includes at least about 0.2% by weight, from about 2% by weight to about 45% by weight, from about 7% by weight to about 45% by weight, from about 9% by weight to about 25% by weight, or even from about 10% by weight to about 22% by weight wax.

When present, the hot melt adhesive composition includes from about 0.2% by weight to about 8% by weight, from about 1% by weight to about 4% by weight, or even from about 2% by weight to about 3.5% by weight functionalized wax.

When present, the hot melt adhesive composition includes from about 0.2% by weight to about 45% by weight, from about 4% by weight to about 35% by weight, or even from about 5% by weight to about 20% by weight non-functionalized wax.

Plasticizer

The hot melt adhesive composition optionally includes a plasticizer. Useful classes of plasticizers include plasticizers that are liquid at room temperature and plasticizers that are solid at room temperature. Useful plasticizers include, e.g., naphthenic petroleum-based oils, paraffinic oils (e.g., cycloparaffin oils), mineral oils, phthalate esters, adipate esters, olefin oligomers (e.g., oligomers of polypropylene, polybutene, and hydrogenated polyisoprene), polybutenes, polyisoprene, hydrogenated polyisoprene, polybutadiene, benzoate esters, animal oil, derivatives of oils, glycerol esters of fatty acids, and combinations thereof.

Useful commercially available plasticizers include plasticizers sold under the NYFLEX series of trade designations including NYFLEX 222B from Nynas Corporation (Houston, Tex.), KAYDOL OIL from Sonneborn (Tarrytown N.Y.), PARAPOL polybutene from Exxon Mobil Chemical Company (Houston, Tex.), OPPANOL polyisobutylene from BASF (Ludwigsjhafen, Germany), BENZOFLEX 352 benzoate ester plasticizer from Velsicol Chemical Company (Chicago, Ill.), KRYSTOL 550 mineral oil from Petrochem Carless Limited (Surrey, England), and CALSOL 550 naphthenic oil from Calumet Specialty Products Partners, LP (Indianapolis, Ind.).

When plasticizer is present in the hot melt adhesive composition, the hot melt adhesive composition includes from about 1% by weight to about 25% by weight, no greater than about 20% by weight, no greater than about 10% by weight, no greater than about 8% by weight, from about 2% by weight to about 25% by weight, or even from about 2% by weight to about 10% by weight plasticizer.

Additives

The hot melt adhesive composition optionally includes a variety of additional components including, e.g., functionalized waxes, antioxidants, stabilizers, additional polymers, adhesion promoters, ultraviolet light stabilizers, rheology modifiers, corrosion inhibitors, colorants (e.g., pigments and dyes), fillers, flame retardants, nucleating agents, and combinations thereof.

Useful antioxidants include, e.g., pentaerythritol tetrakis[3,(3,5-di-tert-butyl-4-hydroxyphenyl)propionate], 2,2′-methylene bis(4-methyl-6-tert-butylphenol), phosphites including, e.g., tris-(p-nonylphenyl)-phosphite (TNPP) and bis(2,4-di-tert-butylphenyl)4,4′-diphenylene-diphosphonite, di-stearyl-3,3′-thiodipropionate (DSTDP), and combinations thereof. Useful antioxidants are commercially available under a variety of trade designations including, e.g., the IRGANOX series of trade designations including, e.g., IRGANOX 1010, IRGANOX 565, and IRGANOX 1076 hindered phenolic antioxidants, and IRGAFOS 168 phosphite antioxidant, all of which are available from BASF Corporation (Florham Park, N.J.), and ETHYL 702 4,4′-methylene bis(2,6-di-tert-butylphenol) (Albemarle Corporation, Baton Rouge, La.). When present, the adhesive composition preferably includes from about 0.1% by weight to about 2% by weight antioxidant.

Useful additional polymers include, e.g., homopolymers, copolymers, and terpolymers, thermoplastic polymers including, e.g., polyolefins (e.g., polyethylene, polypropylene, metallocene-catalyzed polyolefins, and combinations thereof), elastomers including, e.g., elastomeric block copolymers (e.g., styrene-butadiene-styrene, styrene-isoprene-styrene, styrene-ethylene/butene-styrene, styrene-ethylene/propylene-styrene, metallocene-based elastomeric block copolymers, and combinations thereof), and functionalized versions thereof, and combinations thereof. Examples of suitable commercially available polymers include, e.g., EPOLENE C-15 branched polyethylene, and EPOLENE C-10 branched polyethylene, which are available from Westlake Chemical Corporation (Houston, Tex.), and AFFINITY 1900 and 1950 ethylene-octene copolymers, which are available from Dow Chemical Co. (Midland, Mich.).

The optional polymer, when present in the hot melt adhesive composition, is preferably present in an amount no greater than about 25% by weight, no greater than about 20% by weight, no greater than about 15% by weight, no greater than about 10% by weight, or even no greater than about 8% by weight.

The additional polymer optionally is an amorphous polyalphaolefin. Amorphous polyalphaolefins can be made using a variety of processes including, e.g., Ziegler-Natty catalyzed processes. Amorphous polyalphaolefins are commercially available under a variety of trade designations including the REXTAC series of trade designations available from Rextac LLC (Odessa, Tex.) and the EASTOFLEX series of trade designations from Eastman Chemical Company (Kingsport Tenn.). The composition preferably includes no greater than about 8% by weight, no greater than about 5% by weight, no greater than about 2% by weight, or even is free of amorphous polyalphaolefin.

Useful nucleating agents include, e.g., polymeric nucleating agents, minerals, amides, aromatic organic compounds, phosphate ester salts, organic salts and combinations thereof. Examples of suitable nucleating agents include polypropylene, polypropylene wax, polyethylene, polyethylene wax, polystyrene, poly(cyclohexylethylene), stearamides, anthraquinones, fatty acid amides, adipic acid, benzoic acid, benzoic acid salts, phosphate ester salts, sorbitols, kaolin, talc and combinations thereof. The nucleating agent preferably increases the set speed of at least one of the reaction product and the adhesive composition.

### Uses

The hot melt adhesive composition can be applied to or incorporated in a variety of articles including, e.g., films (e.g., polyolefin films (e.g., polyethylene and polypropylene), polyester film, metalized polymer film, multi-layer film, and combinations thereof), fibers, substrates made from fibers (e.g., virgin fibers, recycled fibers, synthetic polymer fibers (e.g., nylon, rayon, polyesters, acrylics, polypropylenes, polyethylene, polyvinyl chloride, polyurethane), cellulose fibers (e.g., natural cellulose fibers such as wood pulp), natural fibers (e.g., cotton, silk and wool), and glass fibers, and combinations thereof), release liners, porous substrates, cellulose substrates, sheets (e.g., paper, and fiber sheets), paper products, woven and nonwoven webs (e.g., webs made from fibers (e.g., yarn, thread, filaments, microfibers, blown fibers, and spun fibers) perforated films, and combinations thereof), tape backings, and combinations thereof.

The hot melt adhesive composition is useful for bonding a variety of substrates including, e.g., cardboard, coated cardboard, paperboard, fiber board, virgin and recycled kraft, high and low density kraft, chipboard, treated and coated kraft and chipboard, and corrugated versions of the same, clay coated chipboard carton stock, composites, leather, polymer (e.g., polyolefin (e.g., polyethylene and polypropylene), polyvinylidene chloride films, ethylene vinyl acetate, polyester, styrene, and polyamide), polymer film (e.g., polyolefin films (e.g., polyethylene and polypropylene), polyvinylidene chloride films, ethylene vinyl acetate films, polyester films, metalized polymer film, multi-layer film, and combinations thereof), fibers and substrates made from fibers (e.g., virgin fibers, recycled fibers, synthetic polymer fibers, cellulose fibers, and combinations thereof), release liners, porous substrates (e.g., woven webs, nonwoven webs, and perforated films), cellulose substrates, sheets (e.g., paper, and fiber sheets), paper products, tape backings, and combinations thereof. Useful composites include, e.g., chipboard laminated to metal foil (e.g., aluminum foil), which optionally can be laminated to at least one layer of polymer film, chipboard bonded to film, Kraft bonded to film (e.g., polyethylene film), and combinations thereof.

The hot melt adhesive composition is useful for bonding a first substrate to a second substrate in a variety of applications and constructions including, e.g., packaging, bags, boxes, cartons, cases, trays, multi-wall bags, articles that include attachments (e.g., straws attached to drink boxes), ream wrap, cigarettes (e.g., plug wrap), filters (e.g., pleated filters and filter frames), bookbinding, footwear, disposable absorbent articles (e.g., disposable diapers, sanitary napkins, medical dressings (e.g., wound care products), bandages, surgical pads, drapes, gowns, and meat-packing products), paper products including, e.g., paper towels (e.g., multiple use towels), toilet paper, facial tissue, wipes, tissues, towels (e.g., paper towels), sheets, mattress covers, and components of absorbent articles including, e.g., an absorbent element, absorbent cores, impermeable layers (e.g., backsheets), tissue (e.g., wrapping tissue), acquisition layers and woven and nonwoven web layers (e.g., top sheets, absorbent tissue), and combinations thereof.

The hot melt adhesive composition is also useful in forming laminates of porous substrates and polymer films such as those used in the manufacture of disposable articles including, e.g., medical drapes, medical gowns, sheets, feminine hygiene articles, diapers, adult incontinence articles, absorbent pads (e.g., for animals (e.g., pet pads) and humans (e.g., bodies and corpses)), and combinations thereof.

The hot melt adhesive composition can be applied to a substrate in any useful form including, e.g., as fibers, as a coating (e.g., a continuous coatings and discontinuous coatings (e.g., random, pattern, and array)), as a bead, as a film (e.g., a continuous films and discontinuous films), and combinations thereof, using any suitable application method including, e.g., slot coating, spray coating (e.g., spiral spray, random spraying, and random fiberization (e.g., melt blowing)), foaming, extrusion (e.g., applying a bead, fine line extrusion, single screw extrusion, and twin screw extrusion), wheel application, noncontact coating, contacting coating, gravure, engraved roller, roll coating, transfer coating, screen printing, flexographic, “on demand” application methods, and combinations thereof.

In on demand hot melt application systems (which are also referred to as “tank free” and “tankless” systems), hot melt compositions are fed in a solid state (e.g., pellets), to a relatively small heating vessel (relative to traditional hot melt applications systems that include a pot) where the hot melt composition is melted and, typically shortly thereafter, the molten liquid is applied to a substrate. In on demand systems, a relatively large quantity of hot melt composition typically does not remain in a molten state for an extended period of time. In many existing on demand systems, the volume of molten hot melt composition is no greater than about I liter, or even no greater than about 500 milliliters, and the hot melt composition is maintained in a molten state for a relatively brief period of time, including, e.g., less than two hours, less than one hour, or even less than 30 minutes. Suitable on demand hot melt adhesive application systems include, e.g., InvisiPac Tank-Free Hot Melt Delivery System from Graco Minnesota Inc. (Minneapolis, Minn.) and the Freedom Hot Melt Dispensing System from Nordson Corporation (Westlake, Ohio). On demand hot melt adhesive application systems are described in U.S. Patent Publication Nos. 2013-0105039, 2013-0112709, 2013-0112279, and 2014-0042182, and U.S. Pat. No. 8,201,717, and incorporated herein.

The invention will now be described by way of the following examples. All parts, ratios, percentages, and amounts stated in the Examples are by weight unless otherwise specified.

### EXAMPLES

### Test Procedures

Test procedures used in the examples include the following. The procedures are conducted at room temperature (i.e., an ambient temperature of from about 20° C. to about 25° C.) unless otherwise specified.

### Viscosity Test Method

Viscosity is determined in accordance with ASTM D-3236 entitled, “Standard Test Method for Apparent viscosity of Hot Melt Adhesives and Coating Materials,” (Oct. 31, 1988), using a Brookfield viscometer, a Brookfield Thermosel heated sample chamber, and a number 27 spindle. The results are reported in centipoise (cps).

### Fiber Tear Test Method

The percentage fiber tear is the percentage of fiber that covers the area of the adhesive after two substrates, which have been previously bonded together through the adhesive, are separated by force. The percentage of fiber tear exhibited by an adhesive composition is determined as follows. A bead of the adhesive composition measuring 15.24 cm (6 inch)×0.24 cm ( 3/32 inch) is applied to a first substrate of ROCKTENN 44 pound 87% virgin liner board, using a ROCKTENN bond simulator at the specified application temperature. Two seconds after the bead of adhesive is applied to the first substrate, the bead of adhesive is contacted with a second substrate of ROCKTENN 44 pound 87% virgin liner board, which is pressed against the adhesive and the first substrate with a pressure of 0.21 MPa (30 pounds per square inch (psi)) for a period of 2 seconds. The resulting constructions are then conditioned at room temperature for at least 4 hours and then conditioned at the specified test temperature for at least 12 hours. The substrates of the construction are then separated from one another at the conditioning temperature (e.g., immediately after removing the sample from the conditioning chamber) by pulling the two substrates apart from one another by hand. The surface of the adhesive composition is observed and the percent of the surface area of the adhesive composition that is covered by fibers is determined and recorded. A minimum of five samples are prepared and tested for each hot melt adhesive composition. The results are reported in units of % fiber tear.

### Set Time Test Method

A bead of adhesive composition measuring 15.24 cm (6 inch)×0.24 cm ( 3/32 inch) is applied to a first substrate of ROCKTENN 44 pound 87% virgin liner board, using a ROCKTENN bond simulator at the specified application temperature. A timer is started as the bead is applied to the first substrate. 0.4 seconds after the bead of adhesive is applied to the first substrate, the bead of adhesive is contacted with a second substrate of ROCKTENN 44 pound 87% virgin liner board, which is pressed against the adhesive and the first substrate with a pressure of 0.21 MPa (30 pounds per square inch (psi)) for a period of 0.4 seconds. When the timer is at 3 seconds, the now formed bond is pulled apart. If the bond results in less than 100% fiber failure, another bond is made and pulled after 3.5 seconds. In this manner, the amount of time that is allowed to elapse prior to pulling the bond is increased in 0.5 second increments until the set time is arrived upon. The set time is the shortest amount of time in which a pulled bond results in 100% fiber failure. Once a set time is achieved, the test is repeated one more time to confirm the result. If the bond gives 100% fiber failure at 3 seconds, the set time is recorded as no greater than 3 seconds. The results are reported in seconds (s).

### Heat Stress Resistance Test Method

Heat stress resistance is measured according to standard number IOPP T-3006 entitled, “Suggested Test Method for Determining the Heat Stress Resistance of Hot Melt Adhesives,” using a starting temperature of 46° C. (115° F.) and five bonded samples per adhesive. After 24 hours, the number of samples that are no longer supporting the weight is recorded, and the temperature is increased. The pass temperature for each adhesive, which is defined as the maximum temperature at which 80% of the samples remain bonded, is the heat stress resistance and is reported in degrees Celsius (° C.).

### Tensile Test Method

Tensile properties are determined using ASTM D638 modified by the film thickness and aging time. Films of each sample are created by using a draw down square, which is preheated to 350° F. (177° C.), with a cut out of 40 mils, which when cooled provides a sample film thickness of 25 mils. Each sample is heated to 350° F. (177° C.), poured onto a Teflon board, and quickly drawn down using the square. Once cooled, the thickness of each film is measured using a micrometer. The target film thickness is 25 mils+/−5 mils, where 1 mil is equal to 0.001 inch (0.00254 mm). Tensile specimens are punched out of the film using a Type IV dog bone die. The thickness of the film specimen is not to vary by greater than 1 mil along the gauge length of a given specimen. Specimens are aged at room temperature for at least 12 hours prior to testing. The specimens are run on an INSTRON 4502 at 23° C., 50% relative humidity, and 2 inch/min extension rate. A calibrated 100 N INSTRON static load cell is used to quantify the force and an INSTRON 2663-821 Advanced Video Extensometer, calibrated using a custom calibration bar, is used to measure the change in the gauge length. BLUE HILL 2 software is used for data acquisition and analysis.

Strain at break is calculated according to the portion of ASTM D638 pertaining to “percent elongation at break” and is reported in percent (%).

Maximum tensile strength is calculated according to the portion of ASTM D638 pertaining to “tensile strength” and is reported in megaPascals (MPa).

Energy to break is calculated by integration of the stress-strain curve, and is reported in Joules (J).

### Gardner Color

A sample is conditioned according to the thermal conditioning procedure set forth in ASTM D-1544 and then tested (in the molten state) to determine Gardner color by comparing the color of the sample against the Gardner Color Standards set forth in ASTM D-1544. The comparison is made using a Gardner Delta Comparator equipped with an Illuminator available from Pacific Scientific (Bethesda, Md.). The result is reported as the number corresponding to the Gardner Color Standard.

### Examples 1-16

The hot melt adhesive compositions of Examples 1-16 were prepared by combining LINXAR 127 propylene-hexene copolymer (ExxonMobil Chemical Company, Houston, Tex.), an ethylene copolymer, and at least one of tackifying resin, wax, oil and antioxidant in the amounts and of the types specified in Tables 1-3 and heating the same to from 175° C. to 180° C. with mixing.

The hot melt adhesive compositions of Examples 1-16 were tested according to the Viscosity test method at 177° C., and the Gardner Color, Strain at Break, Tensile Strength, Energy to Break, Peel Adhesion Failure Temperature, Fiber Tear and Set Time test methods. The results are reported in Tables 1-3.

The hot melt adhesive compositions of Examples 4, 5, 10, 13, and 14 were also tested according to the Heat Stress Resistance test method during which the oven temperature was increased to the following temperatures every 24 hours from a starting temperature of 46° C.: 52° C. (125° F.), 57° C. (135° F.), 60° C. (140° F.), 63° C. (145° F.), and 66° C. (150° F.). The results are reported in Tables 1-3.

TABLE 1

| Example | 1 | 2 | 3 | 4 | 5 | 6 | 7 | 8 | 9 |
|---|---|---|---|---|---|---|---|---|---|
| Ratio of Propylene | 84:16 | 80:20 | 25:75 | 25:75 | 50:50 | 75:25 | 75:25 | 75:25 | 50:50 |
| Polymer to Ethylene | | | | | | | | | |
| Copolymer | | | | | | | | | |
| LINXAR 127¹ | 61.5 | 48 | 10 | 10 | 31 | 45 | 45 | 45 | 30 |
| ESCORENE MV 02514² | 12 | 12 | 0 | 0 | 0 | 0 | 0 | 0 | 0 |
| ATEVA 1880A³ | 0 | 0 | 30 | 30 | 31 | 15 | 15 | 15 | 30 |
| ESCOREZ 5637⁴ | 15 | 20 | 34.4 | 34.4 | 0 | 0 | 0 | 0 | 0 |
| EASTOTAC H130W⁵ | 0 | 0 | 0 | 0 | 15 | 15 | 15 | 15 | 15 |
| SX105⁶ | 0 | 0 | 5 | 0 | 0 | 0 | 0 | 0 | 0 |
| POLYWAX 3000⁷ | 0 | 0 | 0 | 0 | 7 | 5 | 5 | 5.5 | 4 |
| A-C 596⁸ | 1.5 | 0 | 0 | 0 | 0 | 0 | 0 | 0 | 0 |
| A-C 573⁹ | 1.5 | 2 | 0 | 0 | 2 | 2 | 2 | 2 | 2 |
| EPOLENE N21¹⁰ | 8 | 17.5 | 10 | 25 | 13.5 | 10 | 10 | 10 | 8 |
| CWP 400¹¹ | 0 | 0 | 10 | 0 | 0 | 0 | 7.5 | 0 | 0 |
| LICOCENE 6102¹² | 0 | 0 | 0 | 0 | 0 | 7.5 | 0 | 0 | 10.5 |
| CALSOL 550¹³ | 0 | 0 | 0 | 0 | 0 | 0 | 0 | 7 | 0 |
| IRGANOX 1010¹⁴ | 0.5 | 0.5 | 0.4 | 0.4 | 0.5 | 0.5 | 0.5 | 0.5 | 0.5 |
| IRGANOX 1076¹⁵ | 0 | 0 | 0.2 | 0.2 | 0 | 0 | 0 | 0 | 0 |
| Properties | | | | | | | | | |
| Viscosity at 177° C. (cP) | 1135 | 1130 | 1067 | 1625 | 4199 | 970 | 905 | 910 | 1,742 |
| Gardner Color | 1 | 1 | 1 | 1 | 1 | 1 | 1 | 1 | 1 |
| Strain at Break (%) | 264 | 112 | 90 | 238 | 90 | 89 | 78 | 81 | 86 |
| Ultimate Tensile (MPa) | 4.41 | 5.01 | 6.89 | 5.67 | 4.73 | 5.15 | 5.78 | 3.15 | 4.03 |
| Energy to Break (J) | 0.82 | 0.44 | 0.47 | 0.99 | 0.33 | 0.34 | 0.32 | 0.19 | 0.26 |
| PAFT (° C.) | 56 | 60 | 65 | 64 | 53 | 46 | 50 | 33 | 40 |
| Heat Stress Resistance (° C.) | NT | NT | NT | 57 | <46 | NT | NT | NT | NT |
| Fiber Tear | | | | | | | | | |
| 0° F. (−18° C.) | 83 | 26 | 15 | 27 | 58 | 3 | 18 | 3 | 6 |
| 40° F. (4° C.) | 91 | 55 | 5 | 11 | 89 | 4 | 12 | 49 | 3 |
| Room Temp | 99 | 99 | 65 | 92.5 | 100 | 100 | 83 | 96 | 83 |
| 140° F. (60° C.) | 100 | 100 | 100 | 100 | 100 | 98 | 100 | 96 | 100 |
| 150° F. (66° C.) | 98 | 98 | 80 | 95 | 100 | 95 | 96 | 96 | 91 |
| set time (seconds) | <3 | <3 | <3 | <3 | 4 | 3 | 3 | 3 | 5 |

¹= LINXAR 127 propylene hexene copolymer having a density of 0.860 g/cm³, a viscosity of 825 cP at 190° C., and a peak melting temperature of 125° C. (ExxonMobil Chemical Company, Houston, Texas)
²= ESCORENE MV 02514 ethylene vinyl acetate having a vinyl acetate content of 14% and a melt index of 2,500 g/10 min at 190° C. (ExxonMobil Chemical Company, Houston, Texas)
³= ATEVA 1880A ethylene vinyl acetate having a vinyl acetate content of 18% and a melt index of 500 g/10 min at 190° C. (Celanese, Irving, Texas)
⁴= ESCOREZ 5637 aromatic modified, cycloaliphatic hydrocarbon resin (ExxonMobil Chemical Company, Houston, Texas)
⁵= EASTOTAC H-130W hydrogenated hydrocarbon resin (Eastman Chemical Company, Houston, Texas)
⁶= SHELLWAX SX105 Fischer Tropsch wax (Shell Malaysia Ltd., Kuala Lumpur, Malaysia)
⁷= POLYWAX 3000 polyethylene wax (Baker Hughes, Houston, Texas)
⁸= A-C 596P maleated polypropylene wax (Honeywell International Inc., Morristown, New Jersey)
⁹= A-C 573 maleated polypropylene wax (Honeywell International Inc., Morristown, New Jersey)
¹⁰= EPOLENE N21 polyethylene wax (Westlake Chemical Corporation, Houston, Texas))
¹¹= CWP 400 polyethylene wax (SSI CHUSEI, Inc., Pasedena, Texas)
¹²= LICOCENE 6102 polypropylene wax (Clariant Int'l Ltd., Muttenz, Switzerland)
¹³= CALSOL 550 naphthenic oil (Calumet Specialty Products Partners, LP, Indianapolis, Indiana).
¹⁴= IRGANOX 1010 hindered phenolic antioxidant (BASF Corporation, Florham Park, New Jersey)
¹⁵= IRGANOX 1076 hindered phenolic antioxidant (BASF Corporation, Florham Park, New Jersey)
NT= Not Tested

TABLE 2

| Example | 10 | 11 | 12 | 13 |
|---|---|---|---|---|
| Ratio of Propylene | 86:14 | 86:14 | 86:14 | 34:66 |
| Polymer to Ethylene | | | | |
| Copolymer | | | | |
| LINXAR 127 | 64 | 64 | 64 | 20 |
| ESCORENE MV 02514 | 0 | 0 | 0 | 39.5 |
| ATEVA 1880A | 0 | 0 | 0 | 0 |
| EMMA K2090 28- | 10.5 | | | |
| 1000¹⁶ | | | | |
| ENBA ENABLE | 0 | 10.5 | 0 | 0 |
| EN33330¹⁷ | | | | |
| ENBA LOTRYL 35¹⁸ | 0 | 0 | 10.5 | 0 |
| EASTOTAC H130W | 15 | 15 | 15 | 20 |
| POLYWAX 3000 | 0 | 0 | 0 | 0 |
| A-C 573 | 2 | 2 | 2 | 2 |
| EPOLENE N21 | 8 | 8 | 8 | 18 |
| CWP 400 | 0 | 0 | 0 | 0 |
| LICOCENE 6102 | 0 | 0 | 0 | 0 |
| CALSOL 550 | 0 | 0 | 0 | 0 |
| IRGANOX 1010 | 0.5 | 0.5 | 0.5 | 0.5 |
| Total | 100 | 100 | 100 | 100 |
| Properties | | | | |
| Viscosity at 177° C. (cP) | 1,053 | 1,200 | 1,300 | 1,492 |
| Gardner Color | 1 | 1 | 1 | 1 |
| Strain at Break (%) | 228 | 211 | 157 | 92 |
| Ultimate Tensile (MPa) | 4.10 | 3.82 | 3.92 | 3.87 |
| Energy to Break (J) | 0.63 | 0.54 | 0.45 | 0.31 |
| PAFT (° C.) | 44 | 43 | 46 | 43 |
| Heat Stress Resistance | 46 | NT | NT | <46 |
| (° C.) | | | | |
| Fiber Tear | | | | |
| 0° F. (−18° C.) | 36 | 44 | 10 | 47 |
| 40° F. (4° C.) | 57 | 7 | 26 | 31 |
| Room Temp | 100 | 90 | 96 | 100 |
| 140° F. (60° C.) | 95 | 98 | 97 | 93 |
| 150° F. (66° C.) | 87 | 89 | 77 | 86 |
| set time (seconds) | 5 | 5 | 5 | 5 |

¹⁶= EMMA K2090 28-1000 ethylene-methyl methacrylate copolymer having a melt index of 1,000 g/10 min at 190° C. and a methyl methacrylate content of 28% (Celanese Co., Ltd., Irving, Texas)
¹⁷= ENBA EN33330 ethylene n-butyl acrylate copolymer having a melt index of 330 g/10 min at 190° C. (ExxonMobil)
¹⁸= LOTRYL 35 ethylene-n-butyl acrylate having a melt index of from 260 to 350 g/10 min at 190° C. (Arkema, Colombes, France)

TABLE 3

| Example | 14 | 15 | 16 |
|---|---|---|---|
| Ratio of Propylene | 83:17 | 77:23 | 77:23 |
| Polymer to Ethylene | | | |
| Copolymer | | | |
| LINXAR 127 | 72.5 | 67.5 | 67.5 |
| ESCORENE MV 02514 | 0 | 0 | 20 |
| ATEVA 1880A | 15 | 20 | 0 |
| Polywax 3000 | 10 | 10 | 10 |
| A-C 573 | 2 | 2 | 2 |
| IRGANOX 1010 | 0.5 | 0.5 | 0.5 |
| Total | 100 | 100 | 100 |
| Properties | | | |
| Viscosity at 177° C. (cP) | 1,275 | 1,500 | 1,262 |
| Gardner Color | 1 | 1 | 1 |
| Strain at Break (%) | 12 | 9 | 21 |
| Ultimate Tensile (MPa) | 5.34 | 5.04 | 5.39 |
| Energy to Break (J) | 0.05 | 0.04 | 0.09 |
| PAFT (° C.) | 31 | 29 | 27 |
| Heat Stress Resistance | 46 | NT | NT |
| (° C.) | | | |
| Fiber Tear | | | |
| −20° F. (−29° C.) | 53 | 63 | 48 |
| 0° F. (−18° C.) | 47 | 26 | 58 |
| 40° F. (4° C.) | 13 | 17 | 10 |
| Room Temp | 11 | 8 | 14 |
| 130° F. (54° C.) | 0 | 0 | 0 |
| 140° F. (60° C.) | 0 | 0 | 0 |
| 150° F. (66° C.) | 0 | 0 | 0 |
| set time (seconds) | 7 | 7 | 10 |

All publications referred to herein are hereby incorporated by reference.

Other embodiments are within the claims.

What is claimed is:

1. A hot melt adhesive composition comprising:
at least 55% by weight of a polymer component comprising
a propylene polymer other than an amorphous polyalphaolefin, the propylene polymer comprising greater than 50 mole % propylene and exhibiting a melt index greater than 150 grams per ten minutes at 190° C., and
an ethylene copolymer exhibiting a melt index of at least 200 grams per ten minutes at 190° C. and an acid number no greater than 2 milligrams of potassium hydroxide per gram (mg KOH/g) of ethylene copolymer, and derived from ethylene and a co-monomer selected from the group consisting of vinyl acetate, alkyl acrylate, alkyl methacrylate, and combinations thereof,
the ratio of the weight of the propylene polymer to the weight of the ethylene copolymer being from 86:14 to 24:76;
from 0% by weight to no greater than 8% by weight amorphous polyalphaolefin; and
from 0% by weight to no greater than 25% by weight oil,
the hot melt adhesive composition exhibiting at least one property selected from the group consisting of
a strain at break of from at least 50% to no greater than about 630%,
a tensile strength of at least 1.7 megaPascals (MPa),
an energy to break of at least 0.15 Joules, and
combinations thereof.

2. A hot melt adhesive composition comprising:
at least 35% by weight of a polymer component comprising
a propylene polymer other than an amorphous polyalphaolefin, the propylene polymer comprising greater than 50 mole % propylene and exhibiting a melt index of at least 150 grams per ten minutes at 190° C., and
an ethylene copolymer exhibiting a melt index of at least 200 grams per ten minutes at 190° C. and derived from ethylene and a co-monomer selected from the group consisting of vinyl acetate, alkyl acrylate, alkyl methacrylate, and combinations thereof,
the ratio of the weight of the propylene polymer to the weight of the ethylene copolymer being from 50:50 to 24:76;
from 0% by weight to no greater than 8% by weight amorphous polyalphaolefin; and
from 0% by weight to no greater than 25% by weight oil,
the adhesive composition exhibiting a viscosity no greater than 5,000 centipoise at 177° C.

3. A hot melt adhesive composition comprising:
at least 35° A) by weight of a polymer component comprising
a propylene polymer other than an amorphous polyalphaolefin, the propylene polymer comprising greater than 50 mole % propylene and exhibiting a melt index greater than 150 grams per ten minutes at 190° C., and
ethylene vinyl acetate exhibiting a melt index of at least 200 grams per ten minutes at 190° C.,
the ratio of the weight of the propylene polymer to the weight of the ethylene vinyl acetate being from 86:14 to 24:76;
at least 9% by weight of the propylene polymer;
from at least 12% by weight to no greater than 50% by weight of the ethylene vinyl acetate;
from 0% by weight to no greater than 8% by weight amorphous polyalphaolefin; and
no greater than 25% by weight oil.

4. The hot melt adhesive composition of claim 1, wherein the ethylene copolymer comprises ethylene vinyl acetate.

5. The hot melt adhesive composition of claim 2, wherein the ethylene copolymer has an acid number of no greater than 2 mg KOH/g of ethylene copolymer.

6. The hot melt adhesive composition of claim 1, wherein the ratio of the weight of the propylene polymer to the weight of the ethylene copolymer is from 84:16 to 32:68.

7. The hot melt adhesive composition of claim 1, wherein the ratio of the weight of the propylene polymer to the weight of the ethylene copolymer is from 84:16 to 50:50.

8. The hot melt adhesive composition of claim 1, wherein the ratio of the weight of the propylene polymer to the weight of the ethylene copolymer is from 80:20 to 50:50.

9. The hot melt adhesive composition of claim 1, wherein the ethylene copolymer exhibits a melt index of at least 350 g/10 min at 190 CC.

10. The hot melt adhesive composition of claim 1, wherein the ethylene copolymer exhibits a melt index of at least 500 g/10 min at 190° C.

11. The hot melt adhesive composition of claim 1 comprising at least 60% by weight polymer component.

12. The hot melt adhesive composition of claim 1 comprising at least 65% by weight polymer component.

13. The hot melt adhesive composition of claim 1 comprising:
from about 15% by weight to about 80% by weight propylene polymer, and
from about 10.5% by weight to about 60% by weight ethylene copolymer.

14. The hot melt adhesive composition of claim 1, wherein the propylene polymer exhibits a polydispersity index of no greater than 10.

15. The hot melt adhesive composition of claim 1, wherein the propylene polymer comprises a single site catalyzed propylene polymer.

16. The hot melt adhesive composition of claim 1, wherein the propylene polymer is derived from propylene and an alpha-olefin co-monomer comprising two carbon atoms, greater than four carbon atoms, or a combination thereof, the propylene polymer comprising at least 80 mole % propylene and no greater than 20 mole % alpha-olefin co-monomer.

17. The hot melt adhesive composition of claim 1 further comprising a tackifying agent, a wax, a plasticizer other than oil, or a combination thereof.

18. The hot melt adhesive composition of claim 1 further comprising from about 5% by weight to about 30% by weight of a tackifying agent.

19. The hot melt adhesive composition of claim 1 comprising from 1% by weight to no greater than about 20% by weight oil.

20. The hot melt adhesive composition of claim 1 further comprising a wax selected from the group consisting of polyethylene wax, polypropylene wax, Fischer Tropsch wax, paraffin wax, maleated polypropylene wax, maleated polyethylene wax, and combinations thereof.

21. The hot melt adhesive composition of claim 17 comprising:
from about 20% by weight to about 80% by weight propylene polymer,
from about 12% by weight to about 50% by weight ethylene copolymer,
from about 2% by weight to about 45% by weight tackifying agent,
from about 2% by weight to about 45% by weight wax, and
from about 2% by weight to about 25% by weight of the plasticizer other than oil, oil or a combination thereof.

22. The hot melt adhesive composition of claim 21, wherein the wax comprises a first wax and a second wax different from the first wax.

23. The hot melt adhesive composition of claim 1, wherein the hot melt adhesive composition exhibits at least 60% fiber tear at 60° C.

24. The hot melt adhesive composition of claim 1, wherein the hot melt adhesive composition exhibits at least 60% fiber tear at 22° C.

25. The hot melt adhesive composition of claim 1, wherein the hot melt adhesive composition exhibits at least 60% fiber tear at 4° C.

26. The hot melt adhesive composition of claim 1, wherein the hot melt adhesive composition exhibits at least 60% fiber tear at −18° C.

27. The hot melt adhesive composition of claim 1, wherein the hot melt adhesive composition exhibits a peel adhesive failure temperature of at least 49° C.

28. The hot melt adhesive composition of claim 1, wherein the hot melt adhesive composition exhibits a heat stress resistance of at least 60° C.

29. The hot melt adhesive composition of claim 1, wherein the hot melt adhesive composition exhibits a strain at break of from 50% to 600%.

30. The hot melt adhesive composition of claim 1, wherein the hot melt adhesive composition exhibits a strain at break of from 50% to about 300%.

31. The hot melt adhesive composition of claim 1, wherein the hot melt adhesive composition exhibits a tensile strength of at least 2 MPa.

32. The hot melt adhesive composition of claim 1, wherein the hot melt adhesive composition exhibits a tensile strength of from 2.4 MPa to about 8.3 MPa.

33. The hot melt adhesive composition of claim 1, wherein the hot melt adhesive composition exhibits an energy to break of at least 0.3 Joules.

34. The hot inch adhesive composition of claim 1, wherein the hot melt adhesive composition exhibits an energy to break of at least 0.6 Joules.

35. The hot melt adhesive composition of claim 1. wherein the hot melt adhesive composition exhibits an energy to break of from 0.15 Joules to about 5 Joules.

36. The hot melt adhesive composition of claim 1, wherein the hot melt adhesive composition exhibits an energy to break of from 0.15 Joules to about 3 Joules.

37. The hot melt adhesive composition of claim 1, wherein the hot melt adhesive composition exhibits a viscosity of no greater than 6000 centipoise at 177° C.

38. The hot melt adhesive composition of claim 1, wherein the hot melt adhesive composition exhibits a viscosity of no greater than 2,000 centipoise at 177° C.

39. The hot melt adhesive composition of claim 1, wherein the hot melt adhesive composition exhibits a viscosity of no greater than 1,500 centipoise at 177° C.

40. A method of applying the hot melt adhesive composition of claim 1, the method comprising:
melting the hot melt adhesive composition;
maintaining no greater than about 1 liter of the hot melt adhesive composition in a molten state; and
applying the hot melt adhesive composition on a substrate.
